(19) United States
(12) Patent Application Publication
(10) Pub. No.: US 2012/0170588 A1
(43) Pub. Date: Jul. 5, 2012

(54) DATA TRANSMISSION SYSTEM AND DATA TRANSMISSION METHOD

(75) Inventors: Moto Fukunaga, Daito-shi (JP); Masahiro Fukunaga, Iga-shi (JP); Eiji Nakayama, Daito-shi (JP)

(73) Assignee: KYOCERA CORPORATION, Kyoto-shi, Kyoto (JP)

(21) Appl. No.: 13/265,046

(22) PCT Filed: Apr. 5, 2010
(86) PCT No.: PCT/JP2010/056185

§ 371 Date: Nov. 15, 2011

(30) Foreign Application Priority Data
Apr. 22, 2009 (JP) 2009-103875

(51) Int. Cl. H04L 12/56

(52) U.S. Cl. 370/401

(57) ABSTRACT

A transmission unit of a first device transmits, before transmitting at least one data packet including data to be transmitted located in a data region to another device, a first packet notifying that usage of a serial bus is to be started to a second device. The second device includes a flag register storing a bus usage flag representing a usage state of a serial bus. A reception unit of the second device sets the bus usage flag at an engaged state upon receiving the first packet. A transmission transmits a data packet to another device as long as the bus usage flag is not set at an engaged state.

### TECHNICAL FIELD

The present invention relates to a data transmission system and a data transmission method. Particularly, the present invention relates to a data transmission system and a data transmission method having a plurality of devices connected to a multiport switch via a serial bus.

### BACKGROUND ART

In recent years, the amount of communication data is increasing drastically at wireless base stations. In accordance with such increase, the amount of signal processing at devices such as a CPU (Central Processing Unit), DSP (Digital Signal Processor), FPGA (Field Programmable Gate Array) and the like in a substrate for executing the process at wireless base stations is increasing. As a result, the communication rate between these devices has become higher.

Serial RapidIO (registered trademark) is a specification to connect such various types of devices in the substrate to a multipart switch via a serial line to allow high speed communication as fast as 10 Gbps between the devices (for example, refer to RapidIO™ Interconnect Specification Part 1: Input/Output Logical Specification Rev 1.3 (Non-Patent Literature 1)). Devices of the wireless base stations are now being put into practice corresponding to the specification of this Serial RapidIO.

A packet for performing communication is defined according to Serial RapidIO. For example, an NREAD type packet is a read packet requesting a read of data from the device of the other party. An NWRITE type packet is a write packet to write data towards the device of the other party.

Each packet has the priority defined according to its type. A packet output from a device is stored in a buffer located in the multipart switch to be then output to the target device from the buffer. In this buffer, packets towards the same transmission destination sent out from the same transmission source have the output sequence modified according to its priority corresponding to its type. Thus, packets of the same transmission source and same transmission destination can be output in such a manner so as to allow a packet of a higher priority type to be delivered quickly to the destination device.

### CITATION LIST

### Non Patent Literature

NPL 1: RapidIO™ Interconnect Specification Part1: Input/Output Logical Specification Rev.1.3, June 2005, Internet (URL: http://www.rapidio.org/zdata/specs/IO_logical.pdf)

### SUMMARY OF INVENTION

### Technical Problem

In the Serial RapidIO, the priority is not defined between packets corresponding to different destination devices and between packets corresponding to different source devices.

Therefore, when communication of low priority is generated from a device during execution of communication of high priority from another device, communication of the low priority device will also be permitted. As a result, a long period of time will be required until the communication of high priority from a device is completed.

FIG. 12 is a diagram to describe conventional data transmission according to the Serial RapidIO specification.

As shown in FIG. 12, a packet communication with device A as a transmission source (first communication), and a packet communication with device B as a transmission source (second communication) are carried out. It is assumed that the priority of the first communication is higher between the two packet communications. In the case where the buffer in the multiport switch becomes full after device B outputs a data packet A, a signal instructing to wait for the output is transmitted from the multiport switch to each device. As a result, the output of a data packet B from device A will be kept waiting, requiring a long time before the first communication of high priority is completed.

In view of the foregoing, an object of the present invention is to provide a data transmission system and a data transmission method that can prevent communication of high priority from a source device from being hindered by communication of low priority from another source device.

### Solution to Problem

In order to solve the problem set forth above, the present invention is directed to a data transmission system including a multipart switch, and a plurality of devices connected to the multiport switch via a plurality of serial buses. Each of the plurality of devices includes a transmission unit transmitting a packet to another device through the multipart switch and the serial buses, and a reception unit receiving a packet from another device through the multiport switch and the serial buses. At at least one first device among the plurality of devices, the transmission unit transmits, before transmitting at least one data packet including data to be transmitted located in a data region to another device, a first packet notifying that usage of the serial bus is to be started to at least one second device among the plurality of devices. The second device includes a storage unit storing a bus usage flag indicating a usage state of the serial buses. The reception unit sets the bus usage flag to an engaged state upon receiving the first packet. The transmission unit transmits a data packet to another device as long as the bus usage flag is not set at an engaged state.

Preferably, there are a plurality of second devices. The transmission unit of the first device transmits the first packet to a plurality of second devices in a multicast manner.

Preferably, the transmission unit of the first device transmits, after transmission of at least one data packet has ended, a second packet notifying that usage of serial buses is to be ended. The reception unit of the second device sets the bus usage flag at a not-engaged state upon receiving the second packet.

Preferably, there are a plurality of second devices. The transmission unit of the first device transmits the second packet to the plurality of second devices in a multicast manner.

Preferably, there are a plurality of first devices. The transmission unit of each first device also transmits the first packet to another first device. Each first device further includes a storage unit storing a bus usage flag. The reception unit of each first device sets the bus usage flag to an engaged state upon receiving the first packet. The transmission unit of each first device transmits, before transmitting at least one data packet including data to be transmitted, the first packet and the data packet as long as the bus usage flag is not set at an engaged state.

Preferably, the communication through the serial buses follows the Serial RapidIO specification.

The present invention is directed to a data transmission method at a data transmission system including a multiport switch, and a plurality of devices connected to the multipart switch via a plurality of serial buses. The data transmission method includes the steps of: at least one first device among the plurality of devices transmitting, before transmitting at least one data packet including data to be transmitted located in a data region to another device, a first packet notifying that usage of the serial bus is to be started to at least one second device among the plurality of devices; the first device transmitting at least one data packet to another device; the second device receiving the first packet; the second device setting the bus usage flag in a storage unit to an engaged state upon receiving the first packet; and the second device transmitting the data packet to another device as long as the bus usage flag is not set at an engaged state.

### Advantageous Effects of Invention

According to the data transmission method and data transmission method thereof of the present invention, communication of high priority from a source device can be prevented from being hindered by communication of low priority from another source device.

### BRIEF DESCRIPTION OF DRAWINGS

FIG. 1 represents a configuration of a data transmission system according to an embodiment of the present invention.

FIG. 2 represents a configuration of a device A, a device B, and a multiport switch according to a first embodiment.

FIG. 3 represents a configuration, (a) corresponding to a bus usage start notification packet and (b) corresponding to a bus usage end notification packet.

FIG. 4 is a flowchart representing an operation procedure of device A.

FIG. 5 is a flowchart representing an operation procedure of device B,

FIG. 6 is a flowchart representing an exemplified operation of devices A-D.

FIG. 7 is a diagram to describe the exemplified operation in FIG. 6.

FIG. 8 represents a configuration of a device A, a device B, and a multiport switch according to a second embodiment.

FIG. 9 is a flowchart representing an operation procedure of device A.

FIG. 10 is a flowchart representing an exemplified operation of devices A-D.

FIG. 11 is a diagram to describe the exemplified operation in FIG. 10.

FIG. 12 is a diagram to describe a conventional data transmission according to the Serial RapidIO specification.

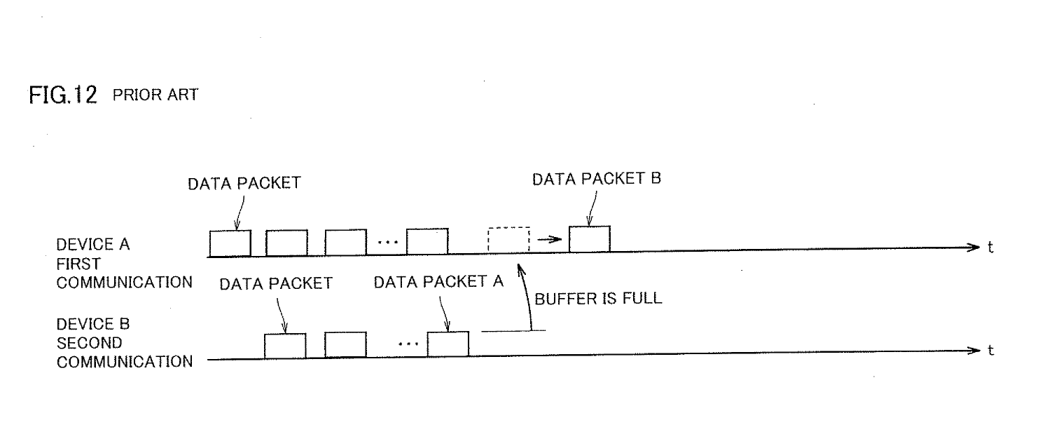

### DESCRIPTION OF EMBODIMENTS

Embodiments of the present invention will be described hereinafter with reference to the drawings.

### First Embodiment

The first embodiment relates to a data transmission system in which there is only one device transmitting data of high priority.

(Configuration of Data Transmission System)

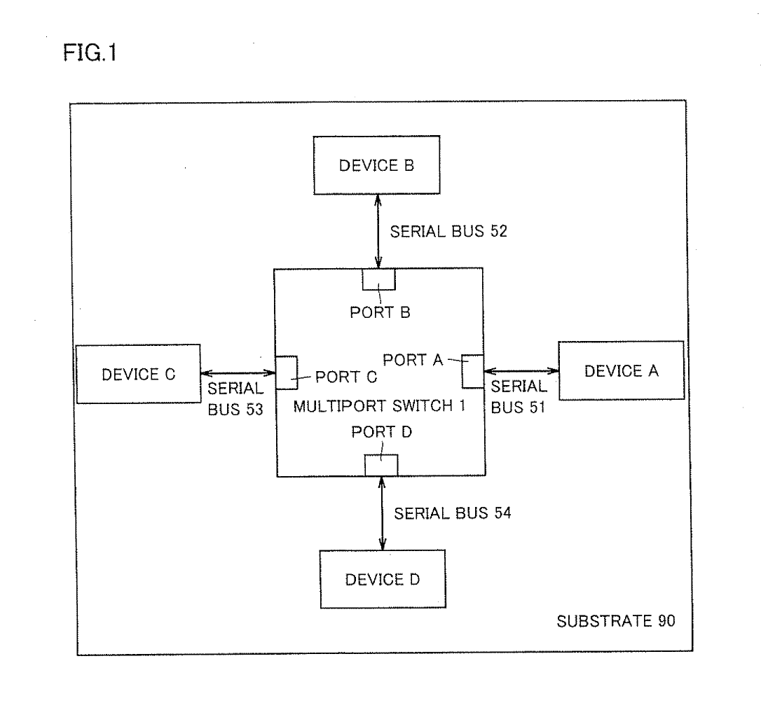

FIG. 1 represents a configuration of a data transmission system according to an embodiment of the present invention.

Referring to FIG. 1, the data transmission system has a plurality of devices A-D and a multipart switch 1 mounted on a substrate 90. Device A is connected to a port A of multipart switch 1 through a serial bus 51. Device B is connected to a port B of multipart switch 1 through a serial bus 52. Device C is connected to a port C of multipart switch 1 through a serial bus 53. Device D is connected to a port D of multipart switch 1 through a serial bus 54.

(Configuration of Device and Multiport Switch)

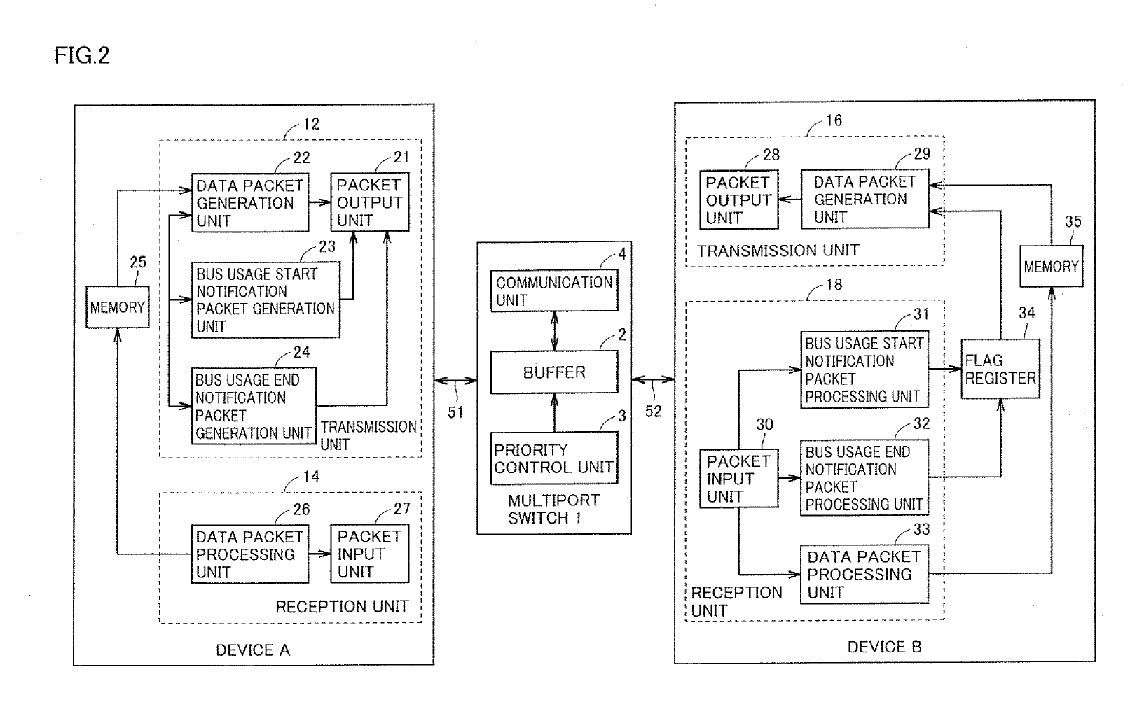

FIG. 2 represents a configuration of device A, device B, and the multipart switch according to the first embodiment. The configuration of device C and device D is similar to that of device B. Therefore, they are not illustrated. It is assumed that the priority in communication with device A as the transmission source is higher than the priority of communication with devices B, C and D as the transmission sources.

Referring to FIG. 2, device A includes a transmission unit 12, a reception unit 14, and a memory 25.

Memory 25 stores data to be transmitted to another device, and data received from another device.

Transmission unit 12 includes a data packet generation unit 22, a bus usage start notification packet generation unit 23, a bus usage end notification packet generation unit 24, and a packet output unit 21.

Data packet generation unit 22 reads out data to be transmitted to a destination device from memory 25 and generates a data packet in which data read out into a data region is included.

Bus usage start notification packet generation unit 23 generates a bus usage start notification packet notifying that usage of serial buses 51-54 is to be started. The bus usage start notification packet has “multicast” designated as the address ID, and is transmitted to all the devices connected to multipart switch 1 other than the source device.

Bus usage end notification packet generation unit 23 generates a bus usage end notification packet notifying that usage of serial buses 51-54 is to be ended. The bus usage end notification packet has “multicast” designated as the address ID, and is transmitted to all the devices connected to multiport switch 1 other than the source device.

Packet output unit 21 outputs the generated data packet, the bus usage start notification packet, and the bus usage end notification packet onto serial bus 51.

Reception unit 14 includes a packet input unit 27, and a data packet processing unit 26.

Packet input unit 27 receives a data packet from serial bus 51.

Data packet processing unit 26 processes the received data packet at packet input unit 27 to write the data included in the data region of the data packet into memory 25.

Device B includes a transmission unit 16, a reception unit 18, a memory 35 and a flag register 34.

Memory 35 stores data to be transmitted to another device, and data received from another device.

Flag register 34 stores a bus usage flag representing the usage state of serial buses 51-54.

Reception unit 18 includes a packet input unit 30, a bus usage start notification packet processing unit 31, a bus usage end notification packet processing unit 32, and a data packet processing unit 33.

Packet input unit 30 receives a data packet, a bus usage start notification packet and a bus usage end notification packet from serial bus 52.

Data packet processing unit 33 processes the data packet received at packet input unit 30 to write the data included in the data region of the data packet into memory 35.

When a bus usage start notification packet is received at packet input unit 30, bus usage start notification packet processing unit 31 updates the value of the bus usage flag in flag register 34 with the data included in the data region of the bus usage start notification packet, i.e. data indicating the start of usage of serial buses 51-54. Accordingly, the bus usage flag is set to an engaged state.

When a bus usage end notification packet is received at packet input unit 30, bus usage end notification packet processing unit 32 updates the value of the bus usage flag in flag register 34 with the data included in the data region of the bus usage end notification packet, i.e. data indicating the end of usage of serial buses 51-54. Accordingly, the bus usage flag is set to a not-engaged state.

Transmission unit 16 includes a data packet generation unit 29, and a packet output unit 28.

As long as the bus usage flag is not set at an engaged state, data packet generation unit 29 reads out data to be transmitted to the destination device from memory 35 to generate a data packet including data read out into the data region.

Packet output unit 28 outputs the generated data packet to serial bus 52.

Multiport switch 1 includes a communication unit 4, a buffer 2, and a priority control unit 3.

Communication unit 4 receives the packet output from the source device through serial buses 51-54 and provides the received packet to buffer 2.

Communication unit 4 also outputs the packet stored in buffer 2 towards the destination device through serial buses 51-54. When the address ID of the packet is set at “multicast”, communication unit 4 transmits that packet to all the devices connected to multiport switch 1 other than the source device.

Priority control unit 3 first takes out the packet of higher priority from buffer 2. Packets of the same priority level are output in a first-in first-output manner (FIFO) from buffer 2. Since the bus usage start notification packet and bus usage end notification packet are set at the highest priority, such packets are taken out foremost, independent of the site stored in buffer 2.

Buffer 2 stores a packet output from a source device, and outputs the packet when the destination device is capable of reception. When the stored amount arrives at a full state, buffer 2 sends a signal indicating to wait for transmission to all devices A-D connected to multiport switch 1.

(Packet Configuration)

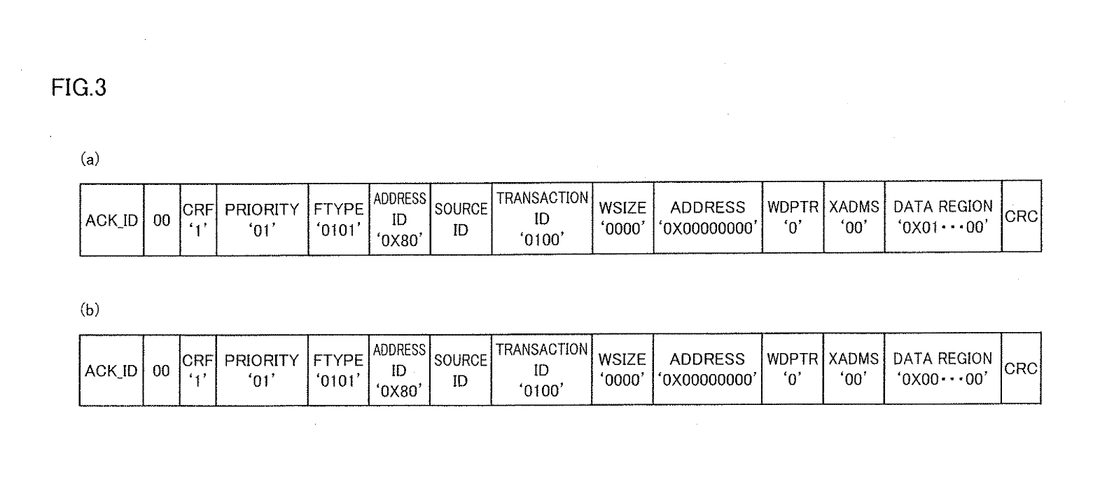

FIG. 3(a) represents a configuration of a bus usage start notification packet.

Referring to FIG. 3(a), ACK_ID has a number set, incremented by 1 at every output of one packet.

CRF and PRIORITY has a value representing the priority set. In this bus usage start notification packet, “1” and “01” representing the highest priority level are set in CRF and PRIORITY, respectively.

FTYPE has “0101” set, representing NWRITE (data writing).

Address ID has “0×80” set, representing multicast.

SOURCE ID has the ID of the device to which the relevant packet is to be output set.

TRANSACTION ID has “0100” set, representing NWRITE.

WSIZE and WDPTR has the size of the data in the data region set. In the present bus usage state start notification packet, “0000” and “0” representing data output of 1 byte are set in WSIZE and WDPTR, respectively.

ADDRESS and XADMS has the address of the site where the data in the data region is to be written set. In this bus usage start notification packet, “0×00000000” and “00” representing the address “0×00” of flag register 34 storing the bus usage flag are set in ADDRESS and XADMS, respectively.

The data region includes 8 bytes of data. In the present bus usage start notification packet, the leading 1 byte is set at “0×01”, and the remaining 7 bytes are set at “0×00”.

CRC has a redundant bit for data error detection set, excluding the 6 bits from the beginning in this packet.

FIG. 3(b) represents a configuration of a bus usage end notification packet.

Referring to FIG. 3(b), this bus usage end notification packet has a configuration substantially similar to that of the bus usage end notification packet of FIG. 3(a), provided that the data in the data region of this bus usage end notification packet indicate “0×00” for all the bytes.

(Operation Procedure of Device A)

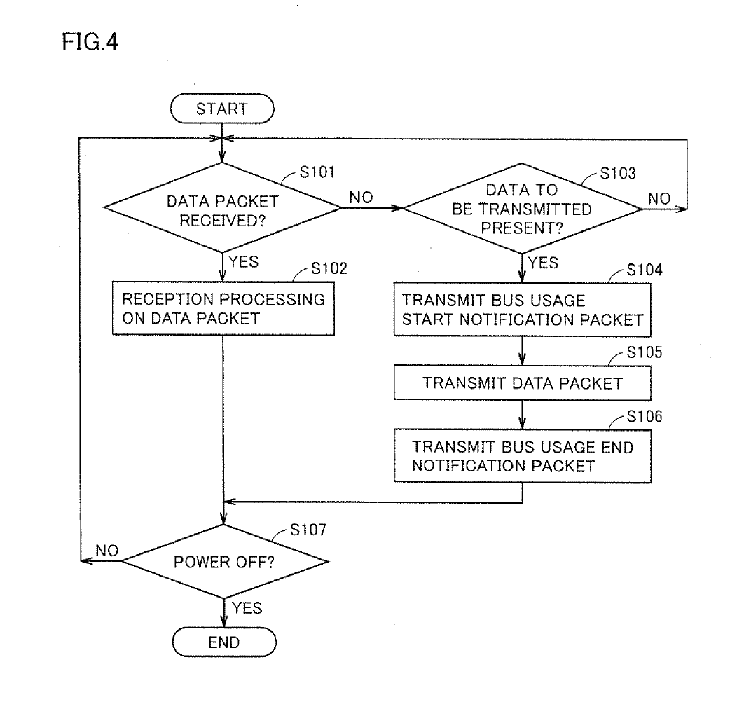

FIG. 4 is a flowchart representing the operation procedure of device A.

First, when packet input unit 27 receives a data packet (YES at step S101), data packet processing unit 26 carries out reception processing on the data packet to write the data included in the data region of the data packet into memory 25 (step S102).

When there is data to be transmitted (YES at step S103), bus usage start notification packet generation unit 23 generates a bus usage start notification packet shown in FIG. 3(a). Packet output unit 21 outputs the generated bus usage start notification packet (step S104).

Then, data packet generation unit 22 generates a data packet including the data to be transmitted to the destination device in the data region. Packet output unit 21 outputs the generated data packet (step S105).

Bus usage end notification packet generation unit 24 generates a bus usage end notification packet shown in FIG. 3(b). Packet output unit 21 outputs the generated bus usage end notification packet (step S106).

(Device B Operation Procedure)

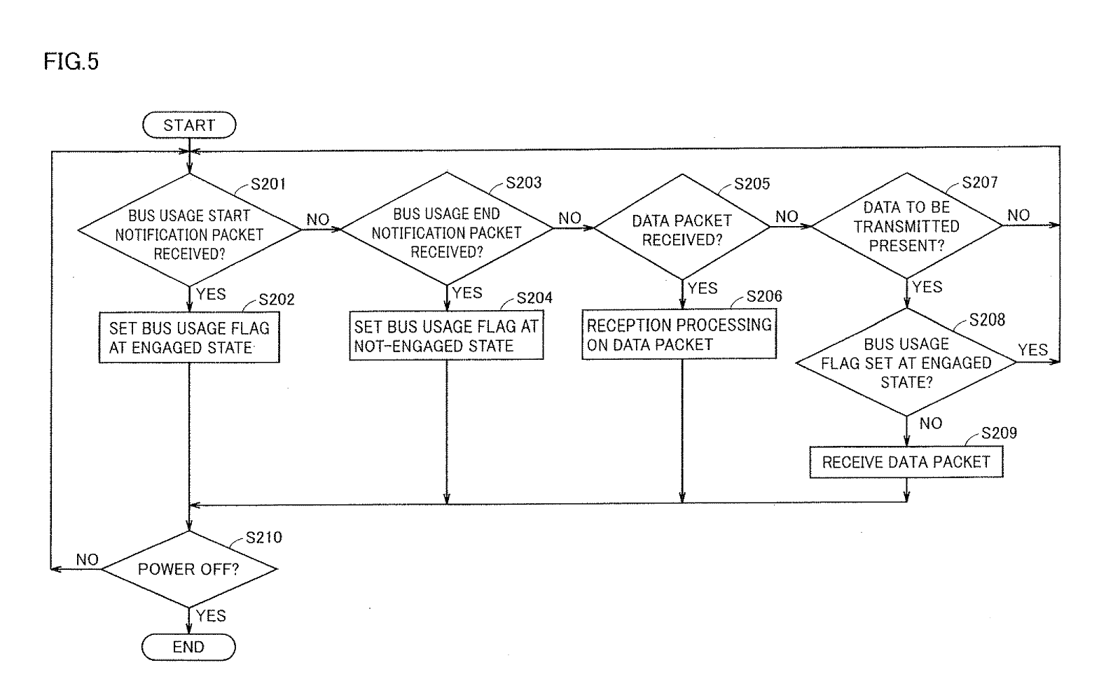

FIG. 5 is a flowchart representing an operation procedure of device B. The operation procedure of device C and device D is similar to that of device B. Therefore, description thereof will not be repeated.

When the bus usage start notification packet shown in FIG. 3(a) is received at packet input unit 30 (YES at step S201), bus usage start notification packet processing unit 31 sets the bus usage flag in flag register 34 at an engaged state (step S202).

When the bus usage end notification packet shown in FIG. 3(b) is received at packet input unit 30 (YES at step S203), bus usage end notification packet processing unit 32 sets the bus usage flag in flag register 34 at a not-engaged state (step S204).

When packet input unit 30 receives a data packet (YES at step S205), data packet processing unit 33 performs reception processing on the data packet, and writes the data included in the data region of the data packet into memory 35 (step S206).

When there is data to be transmitted (YES at step S207), and as long as the bus usage flag in flag register 34 is not set at an engaged state (NO at step S208), data packet generation unit 29 generates a data packet including the data to be transmitted to the destination device in the data region. Packet output unit 28 outputs the generated data packet (step S209).

(Exemplified Operation of Transmission System)

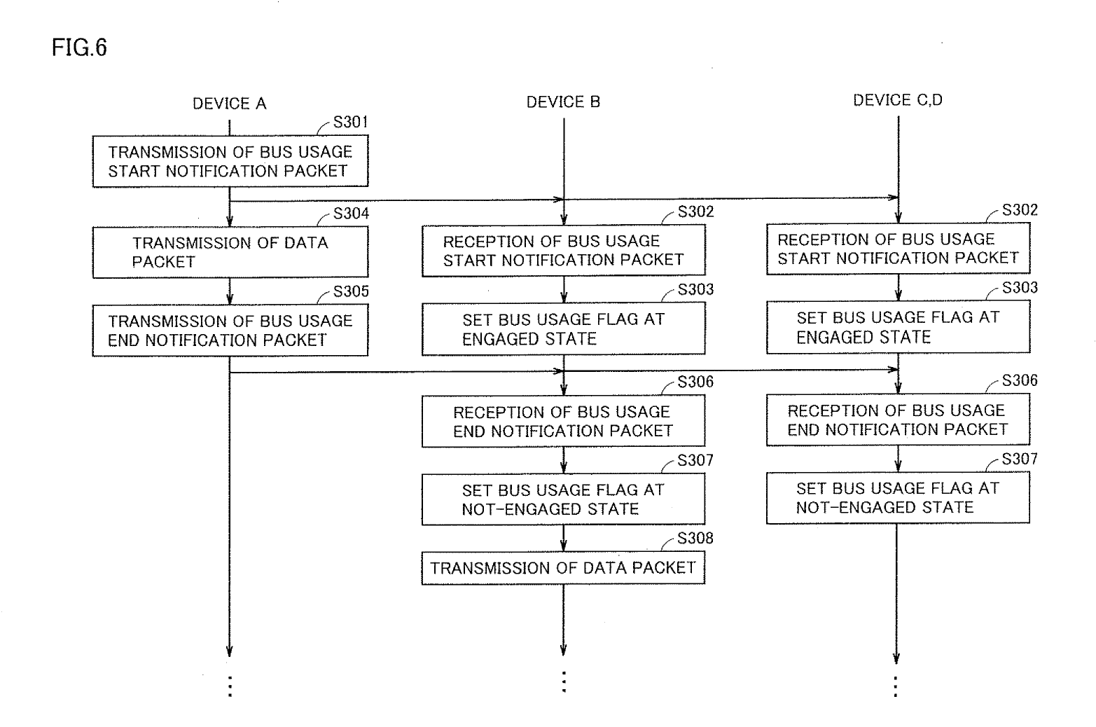

FIG. 6 is a flowchart representing an exemplified operation of devices A-D.

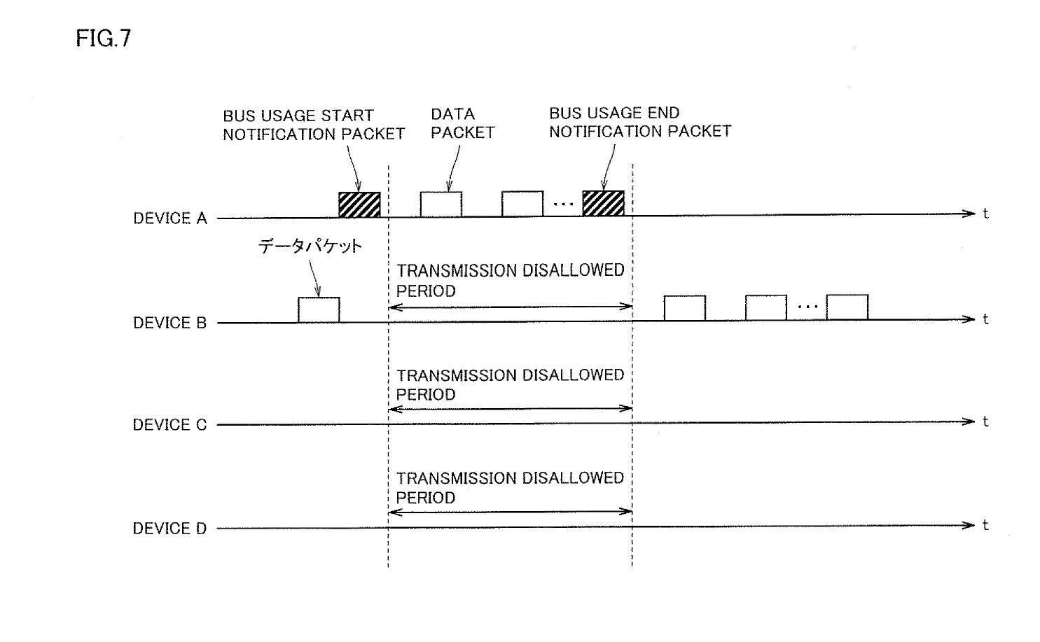

FIG. 7 is a diagram to describe the exemplified operation in FIG. 6.

Referring to FIGS. 6 and 7, at device A, bus usage start notification packet generation unit 23 generates a bus usage start notification packet. Packet output unit 21 outputs the bus usage start notification packet to multiport switch 1 through serial bus 51 (step S301).

At devices B, C and D, packet input unit 30 receives a bus usage start notification packet from multiport switch I via serial buses 52-54 (step S302).

At devices B, C and D, bus usage start notification packet processing unit 31 sets the bus usage flag in flag register 34 at an engaged state. Accordingly, a transmission disallowed period of devices B, C and D is initiated. Devices B, C and D cannot output a data packet during the transmission disallowed period (S303).

At device A, data packet generation unit 22 generates a data packet, and packet output unit 21 transmits the data packet to the destination device via a plurality of serial buses and multiport switch 1 (step S304).

At device A, bus usage end notification packet generation unit 23 generates a bus usage end notification packet. Packet output unit 21 outputs the bus usage end notification packet to multiport switch 1 via serial bus 51 (step S305).

At devices B, C and D, packet input unit 30 receives the bus usage end notification packet from multiport switch I via serial buses 52-54 (step S306).

At devices B, C and D, bus usage end notification packet processing unit 32 sets the bus usage flag in flag register 34 at a not-engaged state. Accordingly, the transmission disallowed period of devices B, C and D ends (step S307).

Then at device B, data packet generation unit 29 generates a data packet since the bus usage flag is not set at an engaged state. Packet output unit 28 outputs the data packet to multiport switch 1 via serial bus 52 (step S304).

According to the transmission system of the present embodiment set forth above, a bus usage start notification packet notifying the start of using a serial bus is transmitted by device A to devices B, C and D. Upon receiving a bus usage start notification packet, devices B, C and D refrain from transmitting data to another device. Accordingly, the communication of high priority with device A as the transmission source is prevented from being hindered by communication of lower priority with devices B, C and D as the transmission sources.

### Second Embodiment

The second embodiment relates to a data transmission system in which there are a plurality of devices transmitting data of high priority.

(Configuration of Device and Multiport Switch)

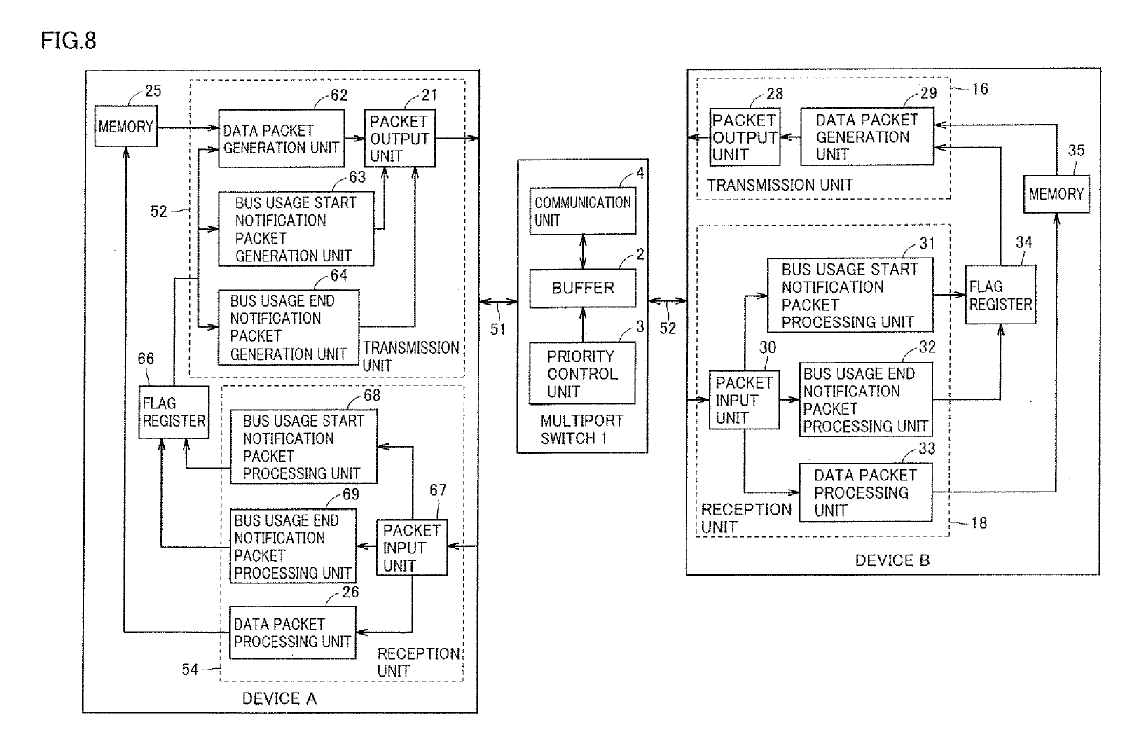

FIG. 8 represents a configuration of device A, device B, and a multiport switch of the second embodiment. The configuration of device C is similar to that of device A, and the configuration of device D is similar to that of device B. Therefore, illustration thereof will not be provided. It is assumed that the priority of communication with device A and C as the transmission sources is higher than the priority of communication with device B and C as the transmission sources

The configuration of FIG. 8 differs from that of the first embodiment shown in FIG. 2 in device A. In other words, device A of the second embodiment differs from device A of the first embodiment in the following features.

Likewise with device B, device A includes a flag register 66 storing a bus usage flag.

Likewise with reception unit 18 of device B, reception unit 54 includes a packet input unit 67, a data packet processing unit 26, a bus usage start notification packet processing unit 68, and a bus usage end notification packet processing unit 69.

Bus usage start notification packet generation unit 63, data packet generation unit 62, and bus usage end notification packet generation unit 64 of transmission unit 52 generate respective packets as long as the bus usage flag in flag register 66 is not set at an engaged state.

(Device A Operation Procedure)

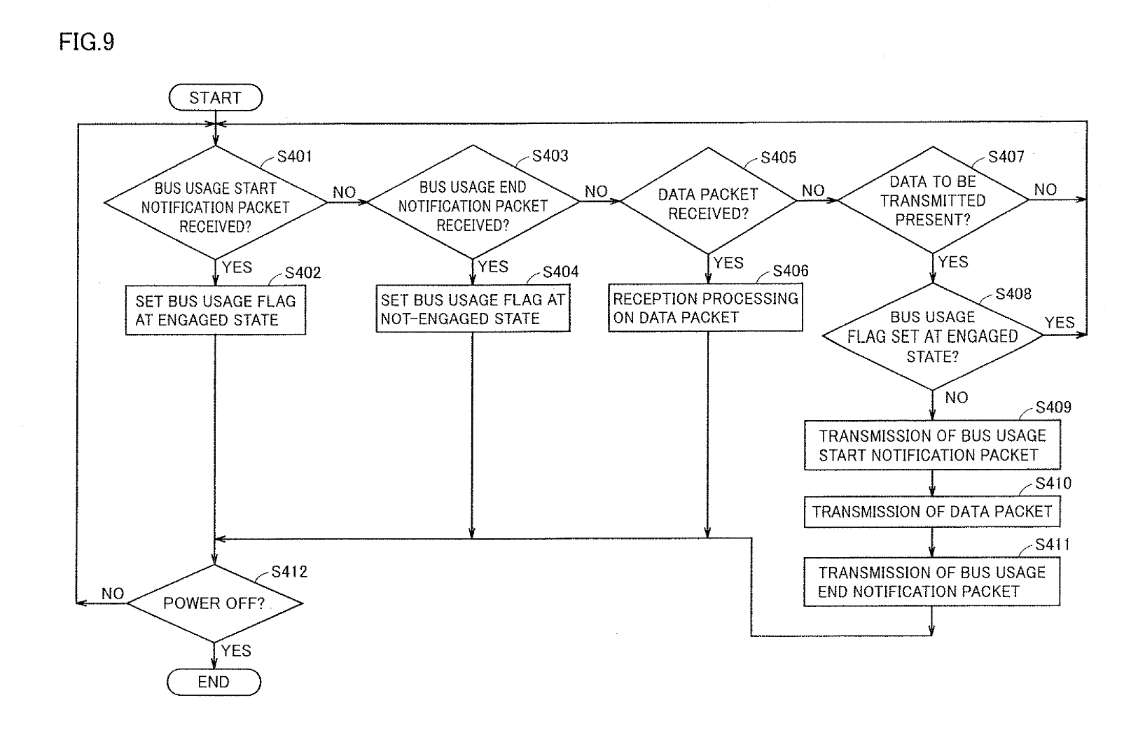

FIG. 9 is a flowchart representing the operation procedure of device A. Since the operation procedure of device C is similar to that of device A, description thereof will not be repeated.

When packet input unit 67 receives a bus usage start notification packet shown in FIG. 3(a) (YES at step S401), bus usage start notification packet processing unit 68 sets the bus usage flag in flag register 65 at an engaged state (step S402).

When packet input unit 67 receives the bus usage end notification packet shown in FIG. 3(b), packet input unit 67 (YES at step S403), bus usage end notification packet processing unit 69 sets the bus usage flag in flag register 66 at a not-engaged state (step S404).

When packet input unit 67 receives a data packet (YES at step S405), data packet processing unit 26 writes the data included in the data region in the data packet into memory 25 according to a data packet reception procedure (step S406).

When there is data to be transmitted (YES at step S407), and as long as the bus usage flag is not set at an engaged state (NO at step S408), bus usage start notification packet generation unit 63 generates a bus usage start notification packet shown in FIG. 3(a). Packet output unit 21 outputs the generated bus usage start notification packet (step S409).

Data packet generation unit 62 generates a data packet including data to be transmitted to the destination device in the data region. Packet output unit 21 outputs the generated data packet (step S410).

Then, bus usage end notification packet generation unit 64 generates a bus usage end notification packet shown in FIG. 3(b). Packet output unit 21 outputs the generated bus usage end notification packet (step S411).

(Operation Procedure of Device B)

The operation procedure of device B and device D are similar to that of device B in the first embodiment. Therefore description thereof will not be repeated.

(Exemplified Operation of Transmission System)

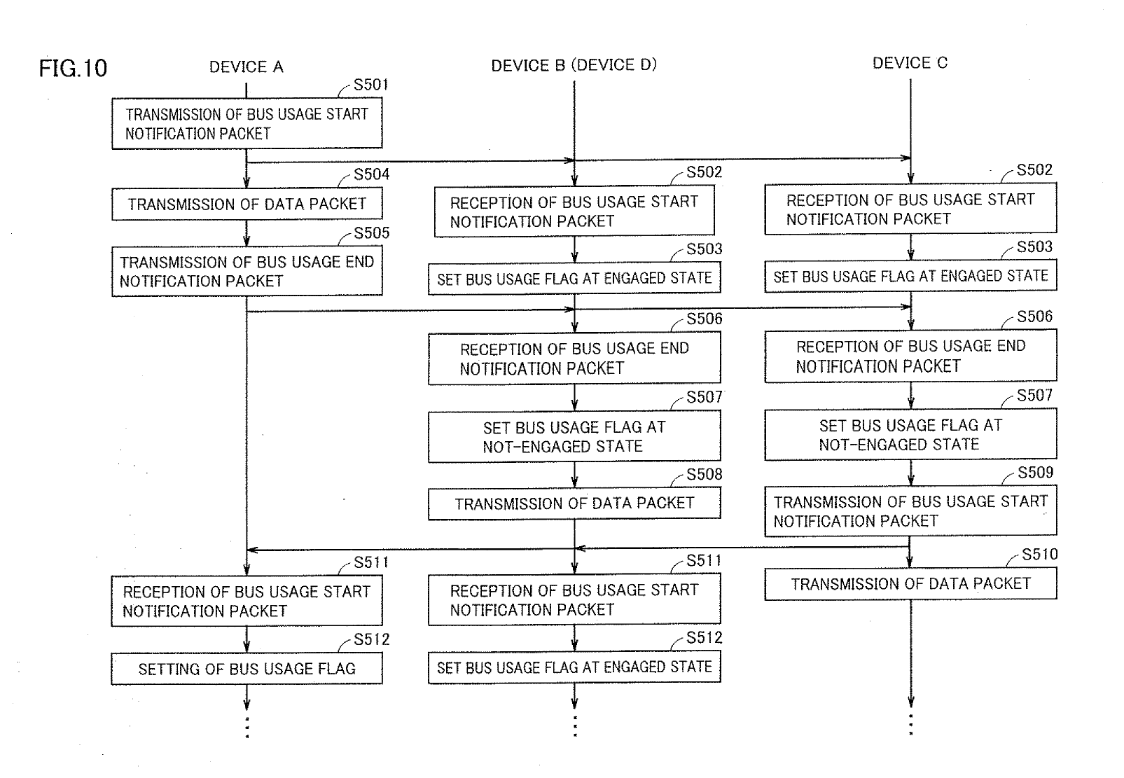

FIG. 10 is a flowchart representing an exemplified operation of devices A-D.

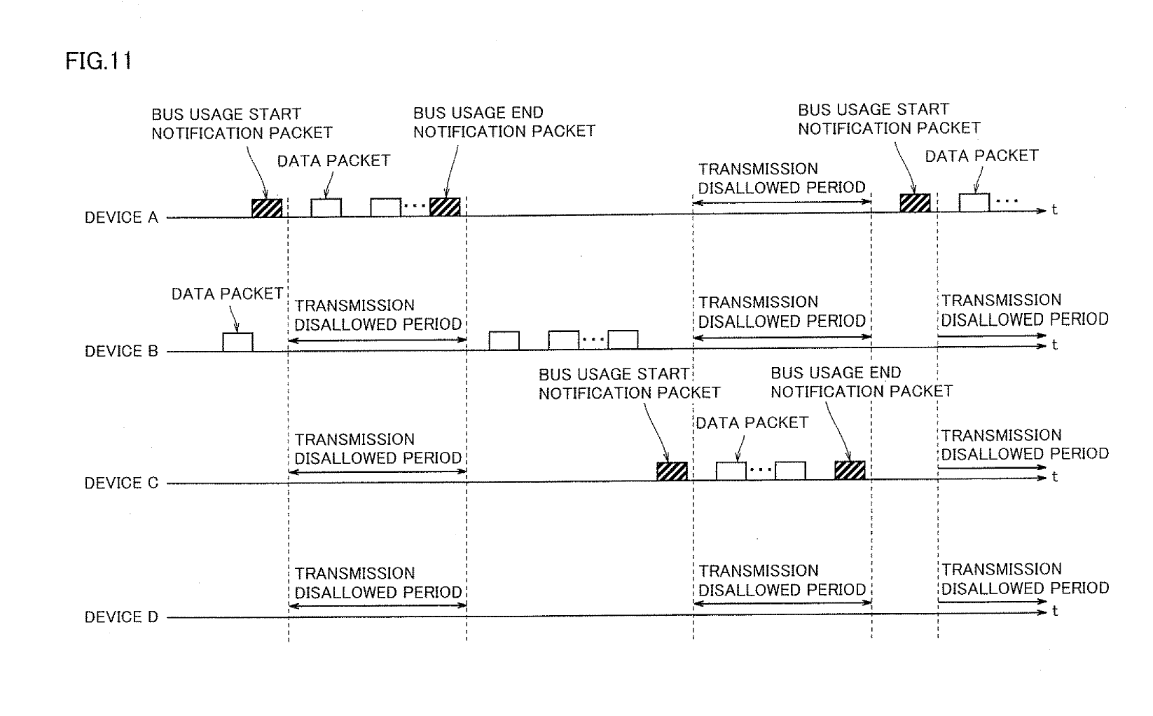

FIG. 11 is a diagram to describe the exemplified operation in FIG. 10.

Referring to FIGS. 10 and 11, at device A, bus usage start notification packet generation unit 63 generates a bus usage start notification packet. Packet output unit 21 outputs the bus usage start notification packet to multipart switch 1 via serial bus 51 (step S501).

At devices B, C and D, packet input units 30, 67 and 30 receive a bus usage start notification packet from multipart switch 1 via serial buses 52, 53, and 54 (step S502).

At devices B, C and D, bus usage start notification packet processing units 31, 68 and 31 set the bus usage flag in flag registers 34, 66 and 34 at an engaged state. Accordingly, the transmission disallowed period of devices B, C and D is initiated. Devices B, C and D cannot output a data packet in a transmission disallowed period (step S503).

Then, at device A, data packet generation unit 62 generates a data packet. Packet output unit 21 transmits the data packet to the destination device through a plurality of serial buses and multipart switch 1 (step S504).

At device A, bus usage end notification packet generation unit 64 generates a bus usage end notification packet. Packet output unit 21 outputs the bus usage end notification packet to multipart switch 1 via serial bus 51 (step S505).

At devices B, C and D, packet input units 30, 67 and 30 receive a bus usage end notification packet from multipart switch I via serial buses 52, 53, and 54 (step S506).

At devices B, C and D, bus usage end notification packet processing units 32, 69 and 32 set the bus usage flag in flag registers 34, 66 and 34, respectively, at a not-engaged state. Accordingly, the transmission disallowed period of devices B, C and D ends (step S507).

At device B, data packet generation unit 29 generates a data packet since the bus usage flag is not set at an engaged state. Packet output unit 28 transmits a data packet to the destination device via a plurality of serial buses and multipart switch 1 (step S508).

At device C, bus usage start notification packet generation unit 63 generates a bus usage start notification packet. Packet output unit 21 outputs the bus usage start notification unit to multipart switch 1 via serial bus 53 (step S509).

At devices A, B and D, packet input units 67, 30 and 30 receive a bus usage start notification packet from multipart switch 1 via serial buses 51, 52 and 54 (step S510).

At devices A, B and D, bus usage start notification packet processing units 68, 31 and 31 set the bus usage flag in flag registers 66, 34 and 34 at an engaged state, respectively. Accordingly, the transmission disallowed period of devices A, B and D is initiated. Devices A, B, and D cannot output a data packet during a transmission disallowed period (step S511).

At device C, data packet generation unit 62 generates a data packet. Packet output unit 21 transmits the data packet to the destination device via a plurality of serial buses and multipart switch 1 (step S512).

Although not shown, device C transmits a bus usage end notification packet, and devices A, B and D set the bus usage flag in flag registers 66, 34 and 34 at a not-engaged state.

According to the transmission system of an embodiment of the present invention, device A transmitting data of high priority transmits a bus usage start notification packet notifying the start of using a serial bus to devices B, C and D. Upon receiving a bus usage start notification packet, devices B, C and D refrain from transmitting data to another device. Therefore, the communication of higher priority with device A as the transmission source can be prevented from being hindered by communication of low priority with devices B, C and D as the transmission sources. Moreover, another device C transmitting data of high priority transmits a bus usage start notification packet notifying the start of using a serial bus to devices B, C and D. Upon receiving a bus usage start notification packet, devices A, B and D refrain from transmitting data to another device. Therefore, the communication of higher priority with device C as the transmission source can be prevented from being hindered by communication of low priority with devices A, B, and D as the transmission sources. Thus, even in the case where there are a plurality of devices to transmit data of high priority, the event of communication of data having higher priority being hindered by the communication of lower priority can be prevented.

It is to be understood that the embodiments disclosed herein are only by way of example, and not to be taken by way of limitation. The scope of the present invention is not limited by the description above, but rather by the terms of the appended claims, and is intended to include any modifications within the scope and meaning equivalent to the terms of the claims.

### REFERENCE SIGNS LIST

A-D device; 1 multiport switch; 2 buffer; 3 priority control unit; 4 communication unit; 12, 16, 52 transmission unit; 14, 18, 54 reception unit; 21, 28 packet output unit; 22, 29, 62 data packet generation unit; 23, 63 bus usage start notification packet generation unit; 24, 64 bus usage end notification packet generation unit; 25, 35 memory; 26, 33 data packet processing unit; 27, 30, 67 packet input unit; 31, 68 bus usage start notification packet processing unit; 32, 69 bus usage end notification packet controlling unit; 34, 66 flag register; 51-54 serial bus.

1. A data transmission system, comprising:
a multiport switch, and
a plurality of devices connected to said multiport switch via a plurality of serial buses,
each of said plurality of devices including
a transmission unit transmitting a packet to another device through said multiport switch and said serial buses, and
a reception unit receiving a packet from another device through said multiport switch and said serial buses,
at at least one first device among said plurality of devices,
said transmission unit transmitting, before transmitting at least one data packet including data to be transmitted located in a data region to another device, a first packet notifying that usage of said serial bus is to be started to at least one second device among said plurality of devices,
at said second device,
including a storage unit storing a bus usage flag representing a usage state of said serial buses,
said reception unit setting said bus usage flag at an engaged state upon receiving said first packet, and
said transmission unit transmitting a data packet to another device as long as said bus usage flag is not set at an engaged state.

2. The data transmission system according to claim 1, wherein
there are a plurality of said second devices, and
the transmission unit of said first device transmits said first packet to said plurality of second devices in a multicast manner.

3. The data transmission system according to claim 1, wherein
the transmission unit of said first device transmits, after transmission of said at least one data packet has ended, a second packet notifying that usage of said serial buses is to be ended, and
the reception unit of said second device sets said bus usage flag at a not-engaged state upon receiving said second packet.

4. The data transmission system according to claim 3, wherein
there are a plurality of second devices, and
the transmission unit of said first device transmits said second packet to said plurality of second devices in a multicast manner.

5. The data transmission system according to claim 1, wherein
there are a plurality of said first devices,
the transmission unit of each said first device transmits said first packet also to another first device,
said each first device further includes a storage unit storing said bus usage flag,
the reception unit of said each first device sets said bus usage flag at an engaged state upon receiving said first packet, and
the transmission unit of said each first device transmits, before transmitting at least one data packet including data to be transmitted, said first packet and said data packet, as long as said bus usage flag is not set at an engaged state.

6. The data transmission system according to claim 1, wherein communication through said serial buses follows a Serial RapidIO specification.

7. A data transmission method at a data transmission system including a multiport switch and a plurality of devices connected to said multipart switch via a plurality of serial buses said method comprising the steps of:
at least one first device among said plurality of devices transmitting, before transmitting at least one data packet including data to be transmitted located in a data region to another device, a first packet notifying that usage of said serial bus is to be started to at least one second device among said plurality of devices,
said first device transmitting said at least one data packet to said another device,
said second device receiving said first packet,
said second device setting a bus usage flag in a storage unit at an engaged state, upon receiving said first packet, and
said second device transmitting a data packet to another device as long as said bus usage flag is not set at an engaged state.
